(19) United States
(12) Patent Application Publication
(10) Pub. No.: US 2025/0239678 A1
(43) Pub. Date: Jul. 24, 2025

(54) POWER STORAGE DEVICE AND METHOD OF MANUFACTURING POWER STORAGE DEVICE

(71) Applicant: TOYOTA JIDOSHA KABUSHIKI KAISHA, Toyota-shi (JP)

(72) Inventors: Shintaro UTSUMI, Susono-shi (JP); Takeru HARA, Toyota-shi (JP); Masataka OGUSHI, Nisshin-shi (JP); Yuji NISHI, Nagoya-shi (JP); Naofumi NOMURA, Nagakute-shi (JP); Nariaki MIKI, Okazaki-shi (JP); Kenta KIMURA, Toyota-shi (JP)

(73) Assignee: TOYOTA JIDOSHA KABUSHIKI KAISHA, Toyota-shi (JP)

(21) Appl. No.: 18/959,895

(22) Filed: Nov. 26, 2024

(30) Foreign Application Priority Data
Jan. 24, 2024 (JP) 2024-008873

(51) Int. Cl. H01M 10/653; H01M 10/04; H01M 10/613; H01M 10/625; H01M 10/647; H01M 10/656; H01M 50/209; H01M 50/289

(52) U.S. Cl. CPC H01M 10/653; H01M 10/0481; H01M 10/613; H01M 10/625; H01M 10/647; H01M 10/656; H01M 50/209; H01M 50/289; H01M 2220/20

(57) ABSTRACT

A power storage device includes a power storage module, a thermally conductive material including a thermally conductive layer stacked on the power storage module in a Z direction, and a cooler stacked on the thermally conductive layer in the Z direction. The cooler includes a contact surface that comes into contact with the thermally conductive layer, and an outer surface opposite to the contact surface. The cooler has a through opening that causes the contact surface to communicate with the outer surface.

### CROSS REFERENCE TO RELATED APPLICATIONS

This nonprovisional application is based on Japanese Patent Application No. 2024-008873 filed on Jan. 24, 2024 with the Japan Patent Office, the entire contents of which are hereby incorporated by reference.

### BACKGROUND

### Field

The present disclosure relates to a power storage device and a method of manufacturing a power storage device. Description of the Background Art

Japanese Patent Laying-Open No. 2023-046670 discloses a power storage device including a case that houses power storage stacks, a cooler, and a thermally conductive material provided between the case and the cooler. The thermally conductive material is sandwiched (pressurized) between the cooler and the power storage stacks (case) to spread (extend).

### SUMMARY

In the power storage device described in Japanese Patent Laying-Open No. 2023-046670 above, an air trap occurs in the thermally conductive material located between the cooler and the power storage stacks in manufacture, resulting in a decrease in the efficiency of cooling the power storage stacks (power storage module) by the cooler.

The present disclosure has been made to solve the problem described above. An object of the present disclosure is to provide a power storage device and a method of manufacturing a power storage device that can suppress a decrease in the efficiency of cooling a power storage module when a thermally conductive material is provided between a cooler and the power storage module.

A power storage device according to a first aspect of the present disclosure includes: a power storage module including a plurality of power storage cells; a thermally conductive material including a thermally conductive layer stacked on the power storage module in a stacking direction; and a cooler stacked on the thermally conductive layer in the stacking direction. The cooler includes a first surface that comes into contact with the thermally conductive layer, and a second surface opposite to the first surface. The cooler has a through opening that causes the first surface to communicate with the second surface.

In the power storage device according to the first aspect of the present disclosure, the through opening that causes the first surface to communicate with the second surface is formed in the cooler. This allows air trapped between the cooler and the power storage module to be discharged from the through opening when the thermally conductive material (thermally conductive layer) is pressurized by the cooler and the power storage module. As a result, the pressurization can be suppressed from being hindered by the air. This can suppress deterioration contact between the cooler and the thermally conductive material (thermally conductive layer) and contact between the power storage module and the thermally conductive material (thermally conductive layer). As a result, a decrease in the efficiency of cooling the power storage module by the cooler can be suppressed.

In the power storage device according to the first aspect described above, preferably, the thermally conductive material includes a filling portion formed contiguous to the thermally conductive layer and filling the through opening. The filling portion is in contact with an inner surface of the through opening. With this configuration, the area of contact between the cooler and the thermally conductive material can be increased by an amount of the area of the inner surface being in contact with the filling portion. This can further suppress a decrease in the efficiency of cooling the power storage module by the cooler.

In this case, preferably, the thermally conductive material includes a projection formed contiguous to the filling portion and projecting from the through opening to a side opposite to the thermally conductive layer. The projection is in contact with the second surface. With this configuration, the area of contact between the thermally conductive material and the cooler can be increased, and also, the deformation of the cooler in the direction in which the through opening passes through can be suppressed.

In the power storage device according to the first aspect described above, preferably, the through opening is formed at a position at which the through opening overlaps, in the stacking direction, a middle portion of the power storage module in a direction intersecting the stacking direction. Herein, air is easily trapped in the middle portion of the power storage module in the direction intersecting the stacking direction. Thus, the configuration described above can effectively discharge the air from the through opening.

In the power storage device according to the first aspect described above, preferably, the through opening is formed at a position at which the through opening overlaps, in the stacking direction, an end of the power storage module in a direction intersecting the stacking direction. Herein, at the end of the power storage module in the direction intersecting the stacking direction, the thermally conductive material easily peels off due to external vibrations or the like. Thus, the configuration described above can suppress deterioration of contact between the thermally conductive material and the power storage module at the end of the power storage module, effectively suppressing peel-off of the thermally conductive material from the power storage module.

In the power storage device according to the first aspect described above, preferably, the plurality of power storage cells are arranged in an arrangement direction intersecting the stacking direction. The through opening is formed at a position at which the through opening overlaps, in the stacking direction, a gap between power storage cells adjacent to each other in the arrangement direction among the plurality of power storage cells. With this configuration, the air trapped between the power storage cells can be easily discharged from the through opening. This can further suppress deterioration of contact between the cooler and the thermally conductive material and contact between the power storage module and the thermally conductive material.

In this case, preferably, a width of the through opening in the arrangement direction is smaller than a width of each of the plurality of power storage cells in the arrangement direction. With this configuration, the area of contact between the cooler and the thermally conductive material can be made larger than when the width of the through opening is not less than the width of the power storage cell. Also, an excessive increase in the amount of the thermally conductive material (thermally conductive layer) between the power storage module and the cooler which is pushed out to the through opening can be suppressed more than when the width of the through opening is not less than the width of the power storage cell.

In the power storage device in which the power storage module includes a plurality of power storage cells, preferably, the width of the through opening in the arrangement direction is greater than the spacing between power storage cells adjacent to each other in the arrangement direction among the plurality of power storage cells.

With this configuration, the air trapped between the cooler and the power storage module can be discharged from the through opening more efficiently than when the width of the through opening is not greater than the spacing described above. Compared to the case where the width of the through opening is not greater than the spacing described above, pushing out the thermally conductive material (thermally conductive layer) between the power storage module and the cooler to the through opening is more facilitated than when it is pushed to the gap between the power storage cells.

In this case, preferably, the through opening is formed to extend in the arrangement direction across at least two or more power storage cells of the plurality of power storage cells. This configuration allows the gap between the power storage cells to easily overlap the through opening in the stacking direction.

A method of manufacturing a power storage device according to a second aspect of the present disclosure includes: a preparation step of preparing a cooler including a first surface and a second surface opposite to the first surface and having at least one through opening that causes the first surface to communicate with the second surface; an application step of applying a thermally conductive material to at least one of the first surface of the cooler and a power storage module including a plurality of power storage cells; a stacking step of stacking, after the application step, the cooler and the power storage module such that the thermally conductive material comes into contact with each of the power storage module and the first surface of the cooler; and a pressing step of pressing, after the stacking step, one of the cooler and the power storage module toward the other of the cooler and the power storage module.

In the method of manufacturing a power storage device according to the second aspect of the present disclosure, as described above, one of the power storage module and the cooler with at least one through opening that causes the first surface to communicate with the second surface is pressed toward the other of the power storage module and the cooler. Thus, the pressing step can be performed while purging the air trapped between the cooler and the power storage module from the through opening. As a result, a method of manufacturing a power storage device can be provided that is able to suppress a decrease in the efficiency of cooling a power storage module by a cooler.

In the method of manufacturing a power storage device according to the second aspect described above, preferably, the at least one through opening includes a plurality of through openings. The pressing step is the step of pressing a portion of the cooler which is provided between through openings among the plurality of through openings toward the power storage module. This configuration can suppress adhesion of the thermally conductive material in the through opening to a jig or the like used in pressing when the thermally conductive material is pushed out to the through opening in the pressing step.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device according to an embodiment.

FIG. 2 is a perspective view showing a configuration of a power storage cell according to the embodiment.

FIG. 3 is a plan view showing a cooler according to the embodiment, as viewed from the Z1 side.

FIG. 4 is a sectional view taken along the line IV-IV of FIG. 3.

FIG. 5 is a sectional view taken along the line V-V of FIG. 3.

FIG. 6 is a flowchart showing a method of manufacturing a power storage device according to the embodiment.

FIG. 7 is a sectional view showing a power storage module and a thermally conductive material after the execution of step S2 of FIG. 6.

FIG. 8 is a sectional view showing the power storage module, the thermally conductive material, and the cooler after the execution of step S3 of FIG. 6.

FIG. 9 is a view showing a pressing member and the cooler used in step S4 of FIG. 6, as viewed from the Z1 side.

FIG. 10 is a first view showing a cross section of a power storage device according to a modification of the embodiment.

FIG. 11 is a second view showing a cross section of a power storage device according to a modification of the embodiment.

FIG. 12 is a third view showing a cross section of a power storage device according to a modification of the embodiment.

FIG. 13 shows a modification of step S2 of FIG. 6.

FIG. 14 shows a modification of step S4 of FIG. 6.

FIG. 15 is a fourth view showing a cross section of a power storage device according to a modification of the embodiment.

### DESCRIPTION OF THE PREFERRED EMBODIMENTS

Embodiments of the present disclosure will be described below in detail with reference to the drawings. The same or corresponding portions in the drawings are denoted by the same reference characters, and description thereof will not be repeated.

The vertical direction will be referred to as a Z direction herein. Specifically, the upward direction and the downward direction of the extension direction will be referred to as a Z1 direction and a Z2 direction, respectively. Each of an X direction and a Y direction is a direction (i.e., horizontal direction) orthogonal to the Z direction. The X direction is orthogonal to the Y direction. The X direction and the Z direction are examples of the “arrangement direction” and the “stacking direction”, respectively, in the present disclosure.

### Configuration of Power Storage Device

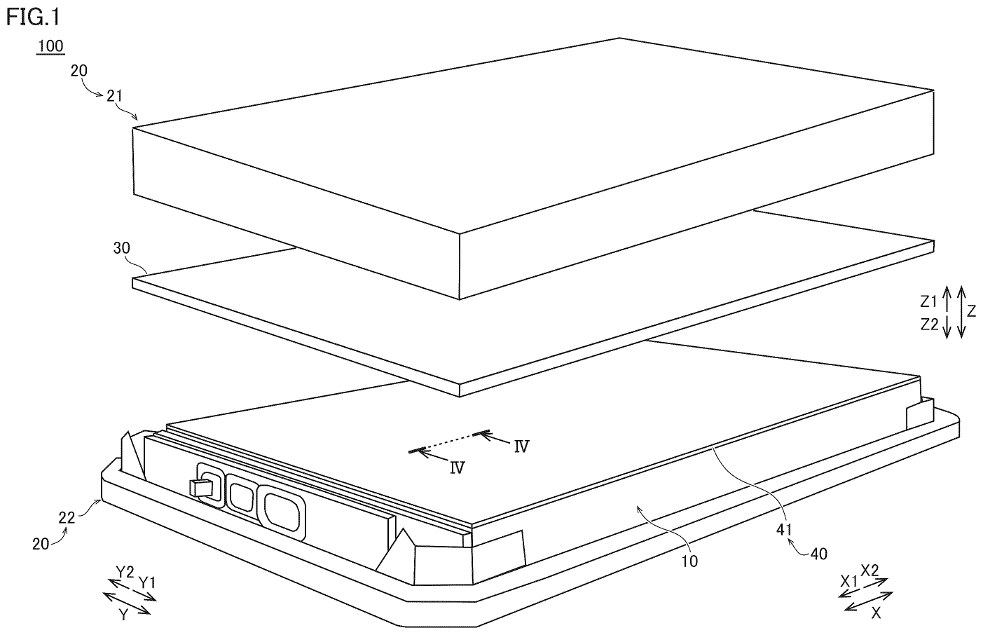

FIG. 1 is a perspective view showing a configuration of a power storage device 100 according to the present embodiment. Power storage device 100 is, for example, a device for storing electric power for driving an electrically powered vehicle (not shown). The X direction shown in FIG. 1 is, for example, the front-rear direction of the electrically powered vehicle. The Y direction is the right-left direction of the electrically powered vehicle. Power storage device 100 may be provided in an electrical device (e.g., stationary power storage device) other than the electrically powered vehicle.

Power storage device 100 includes a power storage module 10, a case 20, a cooler 30, and a thermally conductive material 40. A plurality of power storage modules 10 may be provided. For example, a plurality of power storage modules 10 may be arranged side by side in the X direction.

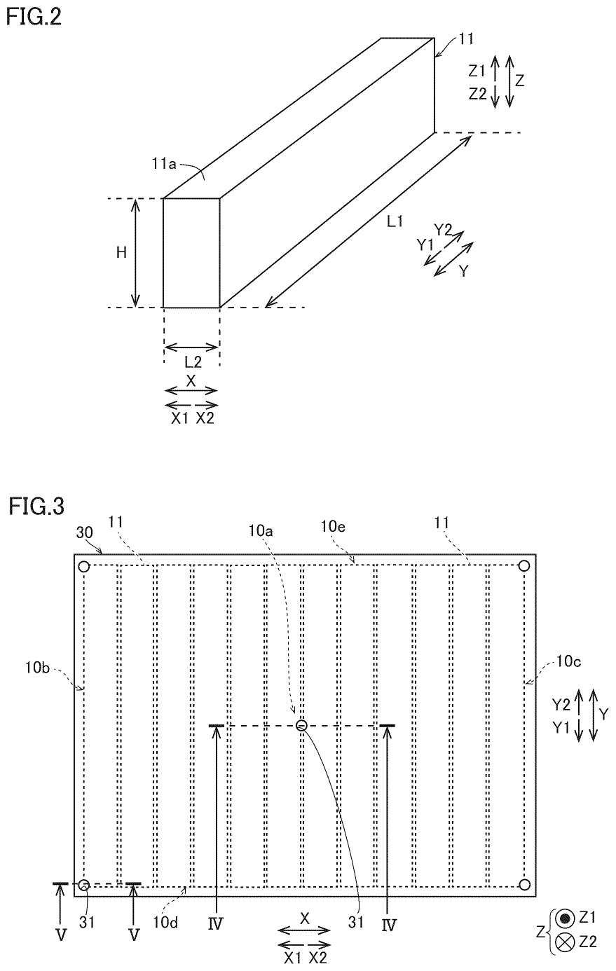

FIG. 2 is a perspective view showing a structure of one of a plurality of power storage cells 11 included in power storage module 10. Power storage cells 11 have the same structure and the same orientation. Each of power storage cells 11 is formed to extend in the Y direction. Specifically, power storage cell 11 has the shape of a prism formed to extend in the Y direction. Power storage cells 11 are arranged (stacked) in the X direction (see FIG. 3).

Power storage cell 11 has a length L1 in the Y direction. Power storage cell 11 has a length L2 in the X direction. Length L1 is greater than length L2. In other words, power storage cell 11 has the Y direction as its longitudinal direction. Power storage cell 11 also has a height H in the Z direction. Height H is smaller than length L1. Height H is greater than length L2. Each of power storage cells 11 may be arranged to extend in the X direction.

Referring again to FIG. 1, case 20 houses power storage module 10. Case 20 includes an upper case 21 and a lower case 22. Power storage module 10 is housed in the space defined by assembly of upper case 21 to lower case 22. Cooler 30 is also housed in the space described above. The configuration of case 20 is not limited to the example shown in FIG. 1. For example, power storage module 10 may be arranged (housed) in a case without an upper case.

Cooler 30 cools power storage module 10. Cooler 30 is arranged above (on the Z1 side of) power storage module 10. Cooler 30 is provided to cover power storage module 10 from the Z1 side. Specifically, cooler 30 is stacked on a thermally conductive layer 41 (described later) included in thermally conductive material 40 in the Z direction. Cooler 30 has the shape of a plate formed to extend along the XY plane. A flow path (not shown) through which a coolant flows is formed in cooler 30.

FIG. 3 is a plan view of cooler 30 as viewed from the Z1 side. As shown in FIG. 3, each of power storage cells 11 is covered with cooler 30 from the Z1 side. A plurality of (five in FIG. 3) through openings 31 are formed in cooler 30. Through openings 31 are formed in the middle portion and four corners of cooler 30. Through opening 31 has the shape of a circle (perfect circle) as viewed from the Z1 side. The position of arrangement, and the number, of through openings 31 in cooler 30 are not limited to the examples described above. Through openings 31 will be described later in detail.

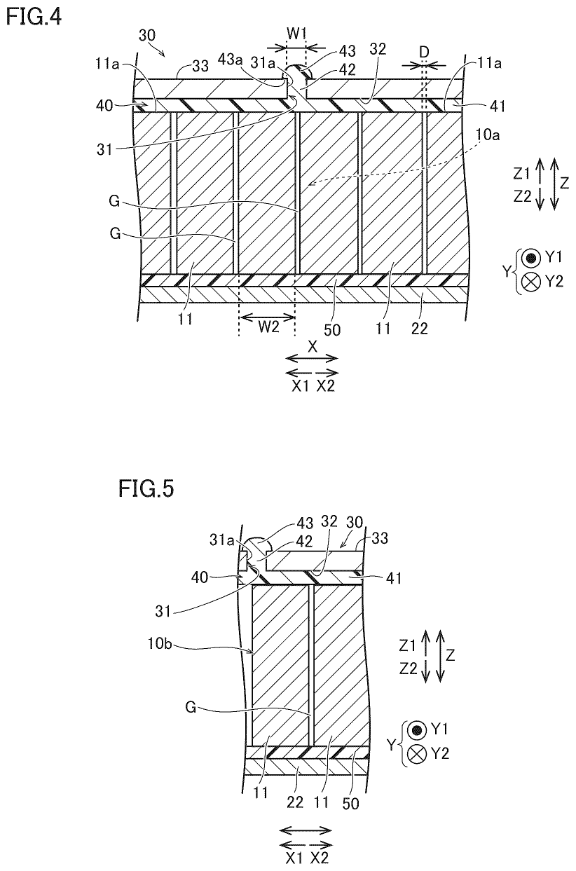

FIG. 4 is a sectional view taken along the line IV-IV of FIG. 1. Thermally conductive material 40 includes thermally conductive layer 41 stacked on power storage module 10 in the Z direction. Thermally conductive layer 41 is arranged on end surfaces 11a of power storage cells 11 on the Z1 side. Thermally conductive layer 41 is sandwiched between power storage module 10 and cooler 30 in the Z direction. In other words, thermally conductive layer 41 is in contact with each of power storage module 10 and cooler 30.

Cooler 30 includes a contact surface 32 and an outer surface 33. Contact surface 32 is in contact with thermally conductive layer 41. Outer surface 33 is a surface opposite to contact surface 32. Contact surface 32 and outer surface 33 are examples of the “first surface” and the “second surface”, respectively, in the present disclosure.

Air may be trapped between the cooler and the power storage module. In manufacture of a power storage device, thus, pressurization of the thermally conductive layer by the cooler and the power storage module may be hindered by the air. In such a case, contact between the cooler and the thermally conductive layer and contact between the power storage module and the thermally conductive layer may deteriorate. This results in a decrease in the efficiency of cooling the power storage module by the cooler.

In the present embodiment, thus, through opening 31 is formed to cause contact surface 32 to communicate with outer surface 33. In other words, through opening 31 is provided to cause the space on the contact surface 32 side to communicate (connect) with the space on the outer surface 33 side. This allows the air trapped between cooler 30 and power storage module 10 to be discharged from through opening 31 in manufacture of power storage device 100.

Through opening 31 is a hole (through hole) formed to extend in the Z direction. Through opening 31 extends so as to be orthogonal to each of thermally conductive layer 41 and cooler 30. Through opening 31 is formed to extend linearly in the Z direction. A width W1 of through opening 31 in the X direction does not change depending on the position in the Z direction. In other words, width W1 remains constant regardless of the position in the Z direction. Width W1 is an example of the “width of the through opening in the arrangement direction” in the present disclosure.

Thermally conductive material 40 includes a filling portion 42. Filling portion 42 is a portion of thermally conductive material 40 which fills through opening 31. Filling portion 42 is formed contiguous to thermally conductive layer 41. Filling portion 42 is a portion pushed out (released) from between cooler 30 and power storage module 10 to through opening 31 when thermally conductive material 40 is pressurized between cooler 30 and power storage module 10.

Filling portion 42 is in contact with an inner surface 31a of through opening 31. Specifically, filling portion 42 fills the entire interior of through opening 31. In other words, there is no space left inside through opening 31 in which thermally conductive material 40 is not provided.

Thermally conductive material 40 includes a projection 43. Projection 43 is a portion projecting from through opening 31 to the side (Z1 side) opposite to thermally conductive layer 41. Projection 43 is formed contiguous to filling portion 42. Projection 43 is a portion of thermally conductive material 40 which overflows (leaks) from through opening 31 when thermally conductive material 40 is pressurized into through opening 31 as described above.

Projection 43 is in contact with outer surface 33 of cooler 30. Projection 43 includes a contact surface 43a that comes into contact with outer surface 33. Contact surface 43a is formed to, for example, surround through opening 31. In other words, contact surface 43a has an annular shape.

Width W1 of through opening 31 in the X direction is smaller than a width W2 of each of power storage cells 11 in the X direction. Width W1 is also greater than a spacing D between power storage cells 11 adjacent to each other in the X direction. For example, width W1 may be not less than twice spacing D. Width W1 may also be not greater than four-fifths of width W2. The width of through opening 31 means a hole size (diameter) of through opening 31. Width W2 is an example of the “width of each of the plurality of power storage cells in the arrangement direction” in the present disclosure.

Through opening 31 is formed at a position at which through opening 31 overlaps, in the Z direction, a gap G between power storage cells 11 adjacent to each other in the X direction. Specifically, gap G is arranged at a position at which gap G overlaps, in the Z direction, the middle portion of through opening 31 in the X direction. Spacing D described above means the width of gap G in the X direction.

Through opening 31 is formed to extend in the X direction across two of power storage cells 11. Specifically, through opening 31 is provided across two power storage cells 11 with gap G, which overlaps through opening 31 in the Z direction, in between.

Referring again to FIG. 3, through opening 31 (through opening 31 in FIG. 4) arranged in the middle of cooler 30 is formed at a position at which through opening 31 overlaps a middle portion 10a of power storage module 10 in the Z direction. Middle portion 10a is positioned in the middle of power storage module 10 in each of the X direction and the Y direction.

Through openings 31 arranged in four corners of cooler 30 are formed at positions at which through openings 31 overlap the ends (10b, 10c) of power storage module 10 in the X direction. End 10b is an X1-side end of power storage module 10. End 10c is an X2-side end of power storage module 10.

Among four through openings 31 arranged in four corners of cooler 30, two through openings 31 on the X1 side are formed at positions at which these through openings 31 overlap end 10b in the Z direction. One of these two through openings 31 on the X1 side is also arranged at a position at which this through opening 31 overlaps, in the Z direction, an end 10d of power storage module 10 on the Y1 side. The other of these two through openings 31 on the X1 side is also arranged at a position at which the other through opening 31 overlaps, in the Z direction, an end 10e of power storage module 10 on the Y2 side.

Among the four through openings 31 described above, two through openings 31 on the X2 side are arranged at positions at which these through openings 31 overlap end 10c in the Z direction. One of these two through openings 31 on the X2 side is also arranged at a position at which this through opening 31 overlaps end 10d of power storage module 10 in the Z direction. The other of these two through openings 31 on the X2 side is also arranged at a position at which the other through opening 31 overlaps end 10e of power storage module 10 in the Z direction.

FIG. 5 is a sectional view taken along the line V-V of FIG. 3. The configurations of through opening 31 and thermally conductive material 40 in FIG. 5 are the same as those of FIG. 4, and thus, redundant description will not be given below.

### Method of Manufacturing Power Storage Device

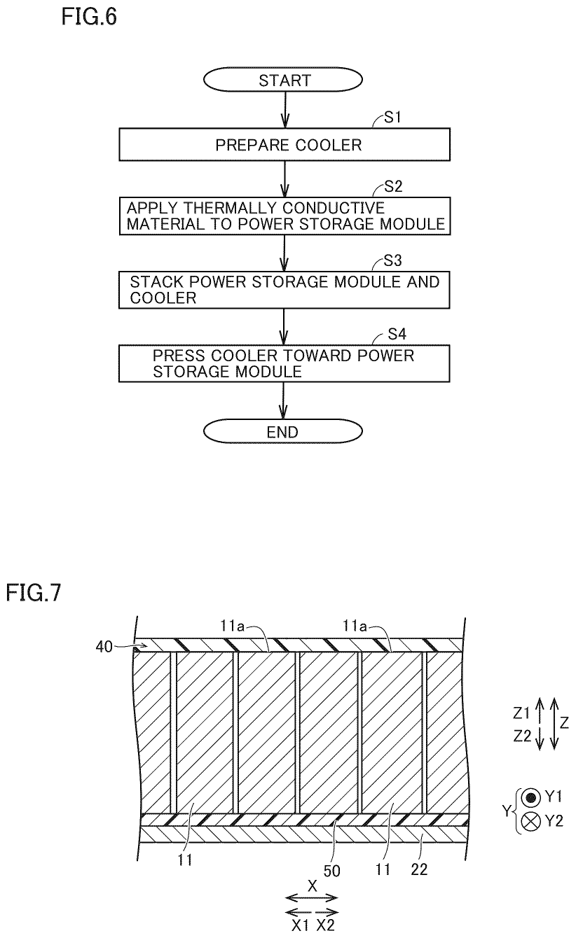

Next, a method of manufacturing power storage device 100 will be described with reference to FIGS. 6 to 9. The method of manufacturing power storage device 100 is not limited to the manufacturing flow shown in FIG. 6.

In step S1, the step of preparing cooler 30 is performed. Specifically, cooler 30 is provided that includes contact surface 32 and outer surface 33 and has through openings 31 that cause contact surface 32 to communicate with outer surface 33.

In step S2, the step of applying thermally conductive material 40 to power storage module 10 is performed. Specifically, thermally conductive material 40 is applied to end surface 11a (see FIG. 7) of each of power storage cells 11. Thermally conductive material 40 may be applied to each power storage cell 11 before power storage cells 11 are arranged in the X direction, or thermally conductive material 40 may be applied to each power storage cell 11 after power storage cells 11 are arranged in the X direction. Although FIG. 7 shows an example in which thermally conductive materials 40 applied to the respective power storage cells 11 are connected to (integrated with) each other, at this time, thermally conductive materials 40 of the respective power storage cells 11 may be spaced apart from each other.

In step S3, the step of stacking power storage module 10 and cooler 30 is performed. Specifically, as shown in FIG. 8, cooler 30 is arranged (stacked) on thermally conductive material 40 stacked on power storage module 10. This causes thermally conductive material 40 to come into contact with each of power storage module 10 and contact surface 32 of cooler 30.

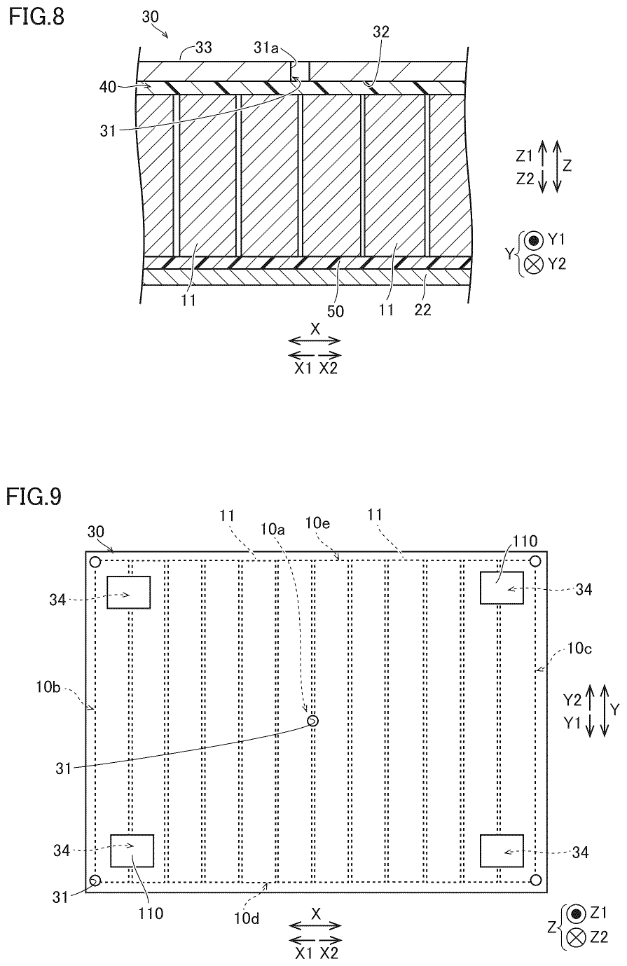

In step S4, the step of pressing cooler 30 toward power storage module 10 is performed. Consequently, thermally conductive material 40 between cooler 30 and power storage module 10 is pressurized. Specifically, as shown in FIG. 9, cooler 30 is pressed to the Z2 side by a plurality of (four in FIG. 9) pressing members 110 disposed on the Z1 side of cooler 30.

Each of pressing members 110 presses a portion 34 of cooler 30 which is provided between through openings 31. Specifically, pressing members 110 press the respective portions 34 provided between through opening 31 corresponding to middle portion 10a and four through openings 31 corresponding to the ends (10b to 10e). Pressing members 110 may simultaneously press cooler 30 (portions 34) with an equal pressing force.

As thermally conductive material 40 is pressurized in the pressing step of step S4, air is discharged from through opening 31, and also, thermally conductive material 40 is pushed to through opening 31. Thus, filling portion 42 and projection 43 are formed. In other words, thermally conductive material 40 is deformed to form filling portion 42 and projection 43.

As described above, in the present embodiment, cooler 30 has through opening 31 that causes contact surface 32 to communicate with outer surface 33. This causes air trapped between cooler 30 and power storage module 10 to be discharged from through opening 31 when thermally conductive material 40 is pressurized by cooler 30 and power storage module 10. As a result, the adhesion between thermally conductive material 40 (thermally conductive layer 41) and each of cooler 30 and power storage module 10 can be further enhanced. This can improve the efficiency of cooling power storage module 10 by cooler 30.

In the present embodiment, thermally conductive material 40 includes filling portion 42 that is formed contiguous to thermally conductive layer 41 and fills through opening 31. Filling portion 42 is in contact with inner surface 31a of through opening 31. As a result, the area of contact between thermally conductive material 40 and cooler 30 can be increased by an amount of the area of inner surface 31a. Since filling portion 42, which is part of thermally conductive material 40, has come in through opening 31, misalignment of cooler 30 can be suppressed.

In the present embodiment, thermally conductive material 40 includes projection 43 that is formed contiguous to filling portion 42 and projects from through opening 31 to the side opposite to thermally conductive layer 41. Projection 43 is in contact with outer surface 33. Consequently, the area of contact between thermally conductive material 40 and cooler 30 can be increased by an amount of the area of contact between projection 43 and outer surface 33. Since projection 43 is in contact with outer surface 33, misalignment of cooler 30 can be suppressed by the portion of contact between projection 43 and outer surface 33.

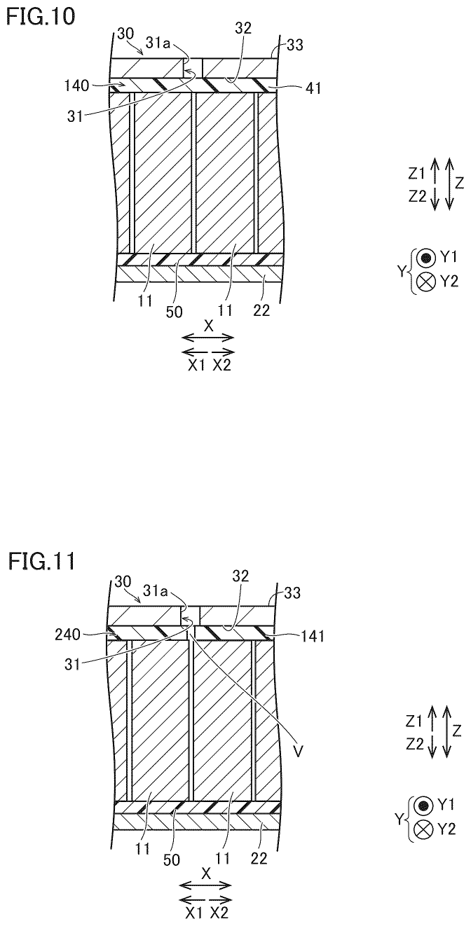

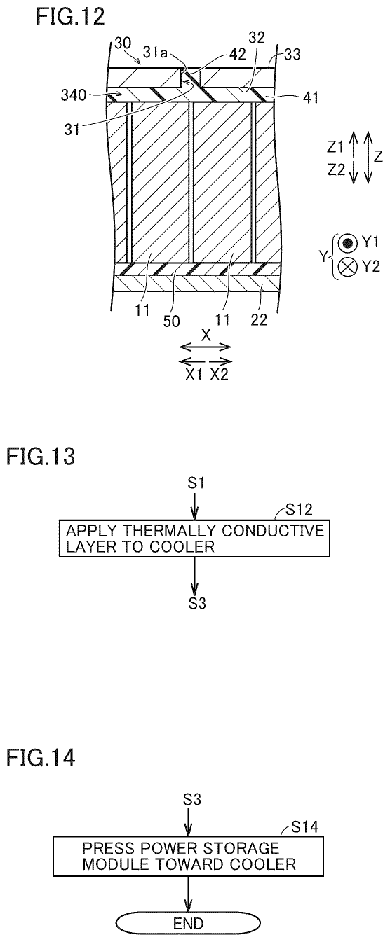

The example in which thermally conductive material 40 includes filling portion 42 and projection 43 is described in the above embodiment, but the present disclosure is not limited thereto. The thermally conductive material may not include filling portion 42 and projection 43. For example, in the example shown in FIG. 10, a thermally conductive material 140 includes only thermally conductive layer 41. In the example shown in FIG. 11, a thermally conductive material 240 includes only a thermally conductive layer 141. Thermally conductive layer 141 has a void space V formed at a position at which void space V overlaps through opening 31 in the Z direction. In the example shown in FIG. 12, a thermally conductive material 340 includes only thermally conductive layer 41 and filling portion 42.

The example in which thermally conductive material 40 is applied to power storage module 10 is described in the method of manufacturing power storage device 100 in the present embodiment, but the present disclosure is not limited thereto. As shown in step S12 of FIG. 13, thermally conductive material 40 may be applied to cooler 30 (contact surface 32).

The example in which cooler 30 is pressed toward power storage module 10 is described in the method of manufacturing power storage device 100 in the above embodiment, but the present disclosure is not limited thereto. As shown in step S14 of FIG. 14, power storage module 10 may be pressed toward cooler 30. Cooler 30 may be pressed toward power storage module 10, and also, power storage module 10 may be pressed toward cooler 30.

The example in which portion 34 between through openings 31 is pressed by pressing member 110 is described in the above embodiment, but the present disclosure is not limited thereto. For example, pressing member 110 may be disposed to block through opening 31.

The example in which through opening 31 extends in the Z direction is described in the above embodiment, but the present disclosure is not limited thereto. For example, a through opening may extend so as to be inclined with respect to the Z direction. A through opening may not be formed linearly. For example, a bent portion, a curved portion, or any other portion may be provided in the through opening.

The example in which filling portion 42 is in contact with inner surface 31a of through opening 31 is described in the above embodiment, but the present disclosure is not limited thereto. The filling portion that fills through opening 31 may be spaced apart from inner surface 31a.

The example in which through opening 31 is formed at a position at which through opening 31 overlaps each of middle portion 10a and the ends (10b to 10e) of power storage module 10 in the Z direction is described in the above embodiment, but the present disclosure is not limited thereto. Through opening 31 may be formed at a position at which through opening 31 overlaps only any one of middle portion 10a and an individual end (10b to 10e) in the Z direction. Through openings 31 may be formed at positions at which through opening 31 overlaps some of ends 10b to 10e in the Z direction. The position at which through opening 31 is arranged with respect to power storage module 10 is not limited to the example described above.

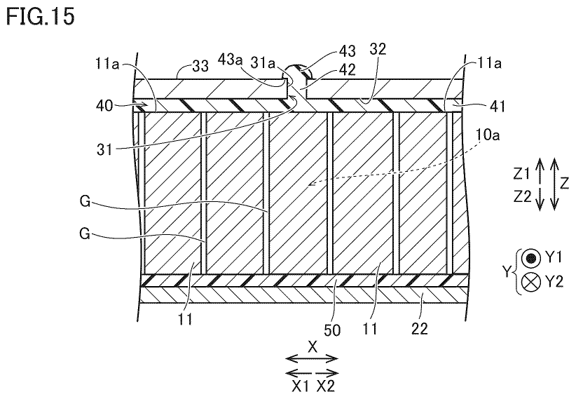

The example in which through opening 31 corresponding to middle portion 10a is formed at a position at which through opening 31 overlaps gap G between power storage cells 11 in the Z direction is described in the above embodiment, but the present disclosure is not limited thereto. For example, as shown in FIG. 15, through opening 31 corresponding to middle portion 10a may be formed at a position at which through opening 31 does not overlap gap G in the Z direction but overlaps only one power storage cell 11 in the Z direction.

The example in which width W1 of through opening 31 in the X direction is smaller than width W2 of power storage cell 11 in the X direction is described in the above embodiment, but the present disclosure is not limited thereto. Width W1 may be not less than width W2.

The example in which width W1 is greater than spacing D between power storage cells 11 is described in the above embodiment, but the present disclosure is not limited thereto. Width W1 may be not greater than spacing D.

The example in which through opening 31 arranged across two power storage cells 11 is formed in cooler 30 is described in the above embodiment, but the present disclosure is not limited thereto. A through opening arranged across three or more power storage cells 11 may be formed in the cooler.

The example in which cooler 30 is pressed by pressing member 110 is described in the above embodiment, but the present disclosure is not limited thereto. For example, a base on which one of power storage module 10 and cooler 30 is placed may be moved toward the other of power storage module 10 and cooler 30 to pressurize thermally conductive material 40.

The example in which cooler 30 is arranged above power storage module 10 is described in the above embodiment, but the present disclosure is not limited thereto. A cooler may be arranged below or to the side of power storage module 10.

The example in which the X direction, the Y direction, and the Z direction are orthogonal to each other is described in the above embodiment, but the present disclosure is not limited thereto. At least two directions of the X direction, the Y direction, and the Z direction may intersect each other without being orthogonal to each other.

The example in which through opening 31 has the shape of a perfect circle as viewed along the Z direction is described in the above embodiment, but the present disclosure is not limited thereto. The through opening may have a rectangular shape or a long hole shape as viewed along the Z direction.

The configurations (processes) of the embodiment and the modifications described above may be combined with each other.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a power storage module including a plurality of power storage cells;
a thermally conductive material including a thermally conductive layer stacked on the power storage module in a stacking direction; and
a cooler stacked on the thermally conductive layer in the stacking direction, wherein
the cooler includes
a first surface that comes into contact with the thermally conductive layer, and
a second surface opposite to the first surface, and
the cooler has a through opening that causes the first surface to communicate with the second surface.

2. The power storage device according to claim 1, wherein the thermally conductive material includes a filling portion formed contiguous to the thermally conductive layer and filling the through opening, and
the filling portion is in contact with an inner surface of the through opening.

3. The power storage device according to claim 2, wherein
the thermally conductive material includes a projection formed contiguous to the filling portion and projecting from the through opening to a side opposite to the thermally conductive layer, and
the projection is in contact with the second surface.

4. The power storage device according to claim 1, wherein the through opening is formed at a position at which the through opening overlaps, in the stacking direction, a middle portion of the power storage module in a direction intersecting the stacking direction.

5. The power storage device according to claim 1, wherein the through opening is formed at a position at which the through opening overlaps, in the stacking direction, an end of the power storage module in a direction intersecting the stacking direction.

6. The power storage device according to claim 1, wherein
the plurality of power storage cells are arranged in an arrangement direction intersecting the stacking direction, and
the through opening is formed at a position at which the through opening overlaps, in the stacking direction, a gap between power storage cells adjacent to each other in the arrangement direction among the plurality of power storage cells.

7. The power storage device according to claim 6, wherein a width of the through opening in the arrangement direction is smaller than a width of each of the plurality of power storage cells in the arrangement direction.

8. The power storage device according to claim 6, wherein a width of the through opening in the arrangement direction is greater than a spacing between power storage cells adjacent to each other in the arrangement direction among the plurality of power storage cells.

9. The power storage device according to claim 8, wherein the through opening extends in the arrangement direction across at least two or more power storage cells of the plurality of power storage cells.

10. A method of manufacturing a power storage device, the method comprising:
a preparation step of preparing a cooler including a first surface and a second surface opposite to the first surface, the cooler having at least one through opening that causes the first surface to communicate with the second surface;
an application step of applying a thermally conductive material to at least one of the first surface of the cooler and a power storage module including a plurality of power storage cells;
a stacking step of stacking, after the application step, the cooler and the power storage module such that the thermally conductive material comes into contact with each of the power storage module and the first surface of the cooler; and
a pressing step of pressing, after the stacking step, one of the cooler and the power storage module toward the other of the cooler and the power storage module.

11. The method of manufacturing a power storage device according to claim 10, wherein
the at least one through opening includes a plurality of through openings, and
in the pressing step, a portion of the cooler is pressed toward the power storage module, the portion being provided between through openings of the plurality of through openings.
